(19) United States
(12) Patent Application Publication
(10) Pub. No.: US 2022/0284390 A1
(43) Pub. Date: Sep. 8, 2022

(54) MOBILE FUEL SUPPLY VEHICLE APPLICATION

(71) Applicant: Ramesh Arumugam, Houston, TX (US)

(72) Inventor: Ramesh Arumugam, Houston, TX (US)

(21) Appl. No.: 17/192,110

(22) Filed: Mar. 4, 2021

(51) Int. Cl. G06Q 10/08; G06Q 20/10

(52) U.S. Cl. CPC G06Q 10/0835; G06Q 20/108

(57) ABSTRACT

An application that allows user to register for mobile fuel supply service, and its additional services. The service is mainly focused on filling fuel to cars that ran out of fuel. The Application service which we build have lot of customer satisfaction indexes, that will give a boost to the needy service and quality service.

### CROSS REFERENCE OF RELATED APPLICATIONS

Not Available

### FIELD OF THE INVENTION

The present invention relates generally to supply mobile fuel to all customers across the globe via a mobile application and also through our hosted website.

### BACKGROUND OF THE INVENTION

The COVID-19 has brought all the business to online processing. We are building an online business application to deliver the fuel gas to demanding business needs, we have designed a quick processing Application system to get the best experience out of the solution. This solution will deliver fuel to the customer's garage.

### SUMMARY

We are trying to develop an Application which will help the stranded users on the road side to book a ready fill fuel supply mobile station services. Which will help the stranded user to fill in the tank with fuel.

### DETAILED DESCRIPTION OF THE INVENTION

Most of the time, it is very difficult to manage vehicles especially the critical one, which is fueling the vehicle. The invention will solve dynamic real-world issue by an invention. It is all about the fuel supplying through mobile vehicles.

### BRIEF DESCRIPTION OF THE DRAWINGS

The Illustration described here will be more fully understood by the reading the specification of the embodiment, referred to herein as the detailed description, when taken alone or with reference to the drawings.

FIG. 1: According to the present disclosure, consumers may be unable to, or would choose not to go to a gas station to get gasoline for their vehicles. An individual may also need emergency gasoline if they run out while driving on the road.

FIG. 2: The customers can order gasoline through a mobile application where our trucks will come to their home, and fill up their vehicles with gasoline. Everything will be handled through a mobile application. Customers can also order the gasoline if they are on the road and have run out of gasoline mid commute.

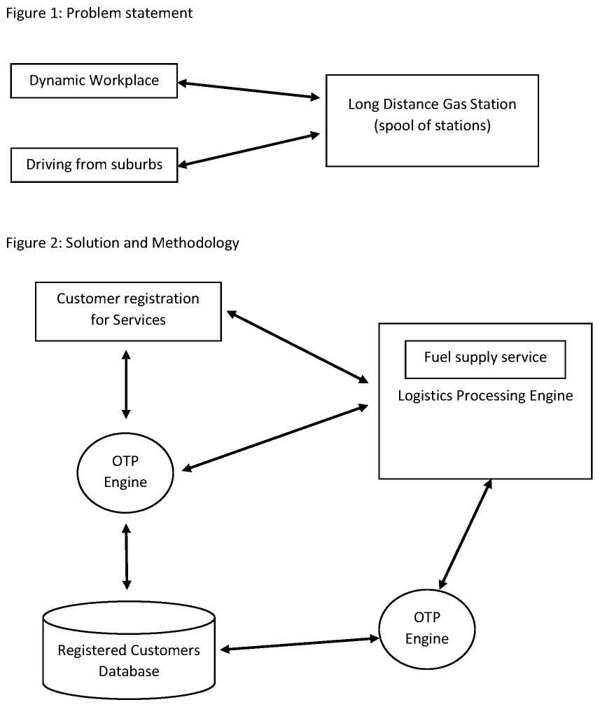

### SPECIFICATION

According to the Customer registration module, customer register for service: —The module helps us to register the customer's user registration process. Simple and significant mandatory least information's are collected and verified.

OTP Engine: —The OTP engine will be the gateway for the information verification, every time when a new customer registered the confirmation will be verified through mobile SMS or via Email. And also every time when the customer book for service to supply fuel, a OTP confirmation will be authenticated to start the service.

Fuel supply service: —The fuel supply service will be initiated with a confirmation SMS and also with an app push message. As soon as the service job triggered, the service will be delivered to the customer.

Logistics processing engine: —This engine will have AI and ML integrated techniques to process the fuel supply vehicle location, delivery confirmation and constant business processes to ensure a quality customer service.

Registered customer's database: —The registered customer database will store only the active customer and the customers who are all in offline will be given 60 days' retention period beyond that, the users information will be removed from the system. It should be understood that the specification above is provided to introduce in simplified form of concepts. Furthermore, the claimed subject matter is not limited to implementations that solve any disadvantages and in any part of this disclosure.

1. Building a consistent, affordable, and Safety enabled business application process system, which concentrates to deliver the demanding business needs.

2. Will have registered Database to have Business intelligent enabled to assist customer a predictable business service.

3. OTP Engine will be in all critical service to ensure all the services are authorized by the customer.

4. Logistics process engine will update constantly about the fuel supply vehicle location and the best possible quick delivery to the nearest customer.

5. Security module with unique encryption features of all stored data of the customers.

6. Additional add-on service will be given to customer as service perks.

7. Payment gateway modules with the most commonly used banking agent's services/API's.
